(19) United States
(12) Patent Application Publication
(10) Pub. No.: US 2008/0155840 A1
(43) Pub. Date: Jul. 3, 2008

(54) Drywall corner bead cutting device

(76) Inventor: Barbara Winkler, Lincoln, NE (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/072,399

(22) Filed: Feb. 26, 2008

Related U.S. Application Data
(63) Continuation-in-part of application No. 10/984,281, filed on Nov. 8, 2004.

(51) Int. Cl. B26D 7/02; B26D 3/00; B26D 1/09

(52) U.S. Cl. 30/360; 30/136; 30/289; 83/167; 83/468.7; 30/304; 30/312

(57) ABSTRACT

An improved drywall corner bead cutting device includes a cutting device base and at least one cutting blade assembly mounted on the cutting device base. The cutting blade assembly includes a corner bead support structure having a corner bead support wall operative to engage the upper wall of a drywall corner bead having a nose and wing sections. A corner bead support structure cutting blade is mounted on the corner bead support structure generally diagonally aligned relative to the corner bead support wall. A pivotably mounted cutting arm includes a cutting blade, the cutting blade positioned adjacent to and parallel with the corner bead support structure cutting blade. Finally, the cutting blade and the corner bead support structure cutting blade cooperate to cut drywall corner bead supported on the corner bead support wall via pivoting movement of the cutting arm to drive the cutting blade and the corner bead support structure cutting blade into and through the drywall corner bead thereby dividing it along a diagonal cut.

### CROSS-REFERENCE TO RELATED APPLICATIONS

The present application is a continuation-in-part of U.S. application Ser. No. 10/984,281 filed Nov. 8, 2004, which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention is directed to drywalling tools and, more particularly, to a drywall corner bead cutting device which includes a drywall corner bead retaining body having a cross-sectional shape approximately similar to the cross-sectional shape of the drywall corner bead to be cut, the retaining body including a longitudinally extended top wall plate and inner and outer base wall retainers for releasably retaining the drywall corner bead within the retaining body and at least one cutting blade assembly movably mounted on the retaining body which includes a handle and a cutting blade which extends through the retaining body to cut the drywall corner bead on a diagonal to permit the cut sections of drywall corner bead to be butted against one another at a joint.

2. Description of Related Art

A vast majority of buildings which are constructed in the United States use drywall to form the interior walls of the building. Briefly, drywall is a sheet material consisting of a uniform layer of gypsum sandwiched between facings of paper which can used as an interior wall covering which can be painted or covered with decorative paper or paneling once installed over the framing for the building. Drywall is generally used for interior walls of buildings as it is relatively inexpensive to manufacture and can be quickly and easily installed in a variety of room configurations. Once of the problems encountered in the use of drywall, however, is that the drywall must be fitted around windows which are built into the sides of the building, thus requiring sections of the drywall to be cut out to permit the window to be seen there through. These cut out sections must then be cleaned up to enhance the appearance of the interior wall and until relatively recently, this was done by merely plastering the edges of the drywall to the window frame to even out the edges of the drywall adjacent the window frame.

A relatively recent innovation in drywall construction, however, is the advent of the drywall corner bead, also known as the bullnose corner bead. This generally consists of an extruded length of plastic sheet having a length of approximately 24″ to 48″ and a width of approximately 2″ to 4″ with the center top section of the corner bead having a generally accurate cross-sectional shape with left and right generally perpendicular sidewalls extending outward from the center section. In use, the drywall corner bead is placed over the intersection between the drywall edge and the window frame such that the top center curved section is positioned over the protruding corner of the cut drywall section. The drywall corner bead is then affixed to the drywall and to the window frame and then would be plastered over thus providing a curved corner adjacent the window which is aesthetically pleasing and far more durable than the cut corner of the drywall section.

One of the disadvantages of the use of drywall corner bead, however, is that the corner angles of the window frame must be accommodated by the drywall corner bead to permit the adjacent sections of the drywall corner bead to butt against one another to provide a seamless and generally continuous wall surface adjacent the window. The cutting of the drywall corner bead to correctly produce these corner joints can be quite difficult, however, and cutters without much experience often make mistakes in making the corner cuts. Briefly, the procedure for cutting the drywall corner bead would include cutting the drywall corner bead to the desired length which corresponds with the inside height or width of the window then taking a pattern which shows how the cut should be made and positioning it adjacent the drywall corner bead. A pencil or other such marking device would then be used to draw a line on the drywall corner bead as delineated by the pattern positioned adjacent the drywall corner bead, the pattern would be placed to the side and the cutter would then use a pair of snips or the like to cut along the drawing line to produce the corner for the one section of drywall corner bead. This must be done for each corner of the window, which means a total of eight cuts must be made to the four sections of the drywall corner bead to produce the desired window frame result, with each cut including each of the above-described steps. Once the process is completed, the drywall corner bead would be placed on the drywall and window frame and affixed in position.

Of course, this process is very time consuming and the final product is only as good as the person following the pencil line with the snips. There is enormous variation in the skill level of persons practicing drywalling, and it is clear that the above-described process provides many opportunities for mistakes to be made which would result in the need for the cutter to begin again, thus increasing the length of time needed to complete the process and resulting in far more waste due to production of unusable sections. There is therefore a need for a cutting device which will eliminate many of the above-described steps yet will produce very accurate and precise results each and every time the cutting device is used.

Therefore, an object of the present invention is to provide an improved drywall corner bead cutting device.

Another object of the present invention is to provide a drywall corner bead cutting device which includes a longitudinally extended top wall plate having a top section with a generally accurate cross-sectional shape and lower inner and outer wall plate sections extending downwards and respectively inwards and outwards from the top section to form a top wall plate having approximately the same cross-sectional shape as the drywall corner bead which will be cut by the present invention.

Another object of the present invention is to provide a drywall corner bead cutting device which includes at least one cutting blade assembly movably mounted on the retaining body which includes a cutting blade mounted on a handle, the cutting blade extending through the top wall plate to cut the drywall corner bead positioned there within, the cut being made quickly and accurately to produce excellent results.

Another object of the present invention is to provide an improved drywall corner bead cutting device which may be quickly and easily used even by novice drywall cutters in order to provide far more consistent and acceptable cutting results regardless of the skill level of the user of the present invention.

Another object of the present invention is to provide an improved drywall corner bead cutting device which includes two cutting blade assemblies, one designed for right-hand cuts and one designed for left-hand cuts, in order to permit use of the present invention regardless of the direction of cut desired to complete the drywall corner bead framing of the window.

Finally, an object of the present invention is to provide an improved drywall corner bead cutting device which is relatively simple in construction and is safe, durable and efficient in use.

### BRIEF SUMMARY OF THE INVENTION

The present invention provides an improved drywall corner bead cutting device which includes a cutting device base and at least one cutting blade assembly mounted on the cutting device base. The cutting blade assembly includes at least one corner bead support section including a corner bead support structure mounted on the cutting device base and having a corner bead support wall operative to engage the upper wall of a drywall corner bead having a nose and wing sections, the corner bead support wall including a nose support section and opposite wing support sections for engaging and supporting the upper wall of a drywall corner bead having a longitudinal axis. A corner bead support structure cutting blade is mounted on the corner bead support structure, the corner bead support structure cutting blade generally diagonally aligned relative to the corner bead support wall such that the corner bead cutting structure cutting blade engages a drywall corner bead supported thereon to cut the drywall corner bead at an angle not perpendicular to the longitudinal axis of the drywall corner bead. A cutting arm section includes a pivotably mounted cutting arm, a handle portion and a cutting blade mounted on the cutting arm, the cutting blade positioned adjacent to and parallel with the corner bead support structure cutting blade. Finally, the cutting blade and the corner bead support structure cutting blade are cooperatively operative to cut drywall corner bead supported on the corner bead support wall and extending beyond the corner bead support structure cutting blade into a cutting area defined by interaction of the cutting blade and the corner bead support structure cutting blade via pivoting movement of the cutting arm to drive the cutting blade and the corner bead support structure cutting blade into and through a drywall corner bead thereby dividing the drywall corner bead along a diagonal cut.

The present invention as thus described provides many improvements to the drywall corner bead cutting methods which were previously used. For example, the cutting skill level of the drywaller becomes less important as the present invention is designed to make accurate, repeatable cuts each and every time the invention is used. Also, because the drywall corner bead is completely supported adjacent the cutting area by resting on the corner bead cutting structure, the correct positioning and cutting of the drywall corner bead within the invention can be accurately determined and performed after the initial measurement is made, thus greatly reducing the possibility of an incorrect cut at an incorrect location being made. Furthermore, because the cutting blade of the present invention is movably mounted to the base, it is not used in a “freehand” manner, thus greatly reducing the possibility for injury which often occurs when using a sharp cutting blade to cut a piece of plastic such as the drywall corner bead. Also, because the present invention includes a safety bar, the likelihood of injury resulting from use of the present invention is greatly reduced. Finally, the expected useable life span for the invention is quite long and it should be relatively inexpensive to manufacture, thus making it available for a vast majority of drywall erectors in the industry. It is thus seen that the present invention provides a substantial improvement over those devices and methods found in the prior art.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of the drywall corner bead cutting device of the present invention;

FIG. 2 is a top plan elevational view of the present invention showing the positioning of the cutting blade assemblies mounted thereon;

FIGS. 3a and 3b are detailed side elevational views showing the blade cutting a drywall corner bead positioned within the retaining body;

FIG. 4 is a detailed perspective view of two drywall corner beads after they are cut by the present invention being positioned adjacent one another in a generally perpendicular arrangement;

FIG. 5 is a perspective view of a standard window showing how the cut drywall corner beads are positioned around the inner frame of the window to connect to the surrounding drywall sections;

FIG. 6 is a perspective view of an alternative embodiment of the present invention having only a single cutting blade;

FIG. 7 is a perspective view of a preferred alternative embodiment of the present invention cutting a section of drywall corner bead;

FIG. 8 is a perspective view of the preferred alternative embodiment of FIG. 7;

FIG. 9 is a top plan view of the preferred alternative embodiment of FIG. 7;

FIG. 10 is a detailed perspective view of the preferred alternative embodiment of FIG. 7

FIG. 11 is a detailed side elevational view of the preferred alternative embodiment of FIG. 7;

FIGS. 12 and 13 are detailed perspective views of different styles of corner bead support structures and blades used with the preferred alternative embodiment of FIG. 7; and

FIGS. 14 and 15 are detailed perspective views of corner bead fitted together after being cut by the preferred alternative embodiment of FIG. 7.

### DETAILED DESCRIPTION OF PREFERRED EMBODIMENT

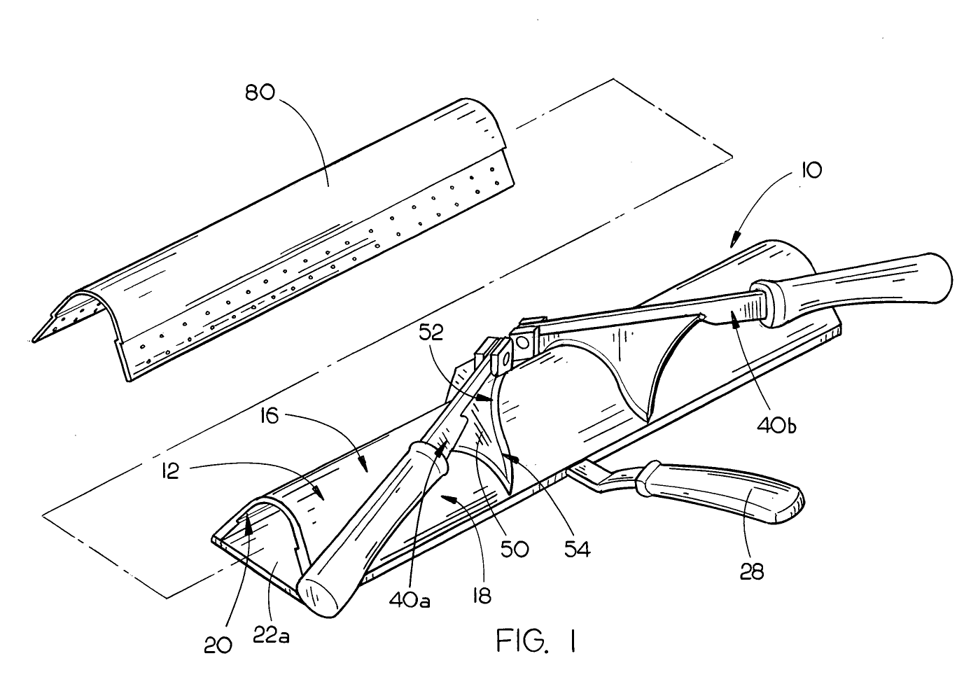

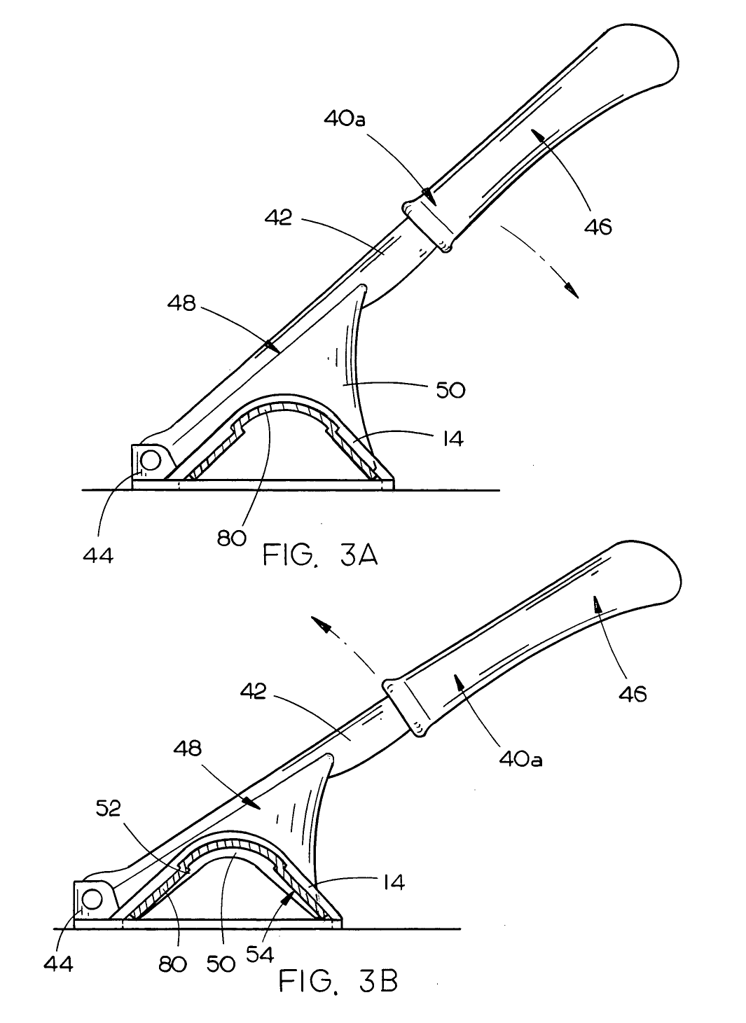

The drywall corner bead cutting device 10 of the present invention is shown best in FIGS. 1-3 as including a drywall corner bead retaining body 12 and two cutting blade assemblies 40a and 40b which are pivotally mounted on the retaining body 12 as will be described later in this disclosure. In the preferred embodiment, the retaining body 12 would include a longitudinally extended top wall plate 14 having a length of approximately 6 to 12 inches and a width of approximately 1 to 4 inches, and the top wall plate 14 would preferably be constructed of a sturdy sheet metal or the like. Top wall plate 14 preferably includes three integrally connected sections, a top section 16 having a generally accurate cross-sectional shape, a lower inner wall plate section 18 extending downwards and inwards from the top section 16 and a lower outer wall plate section 20 which extends downwards and outwards from the top section 16 as shown best in FIGS. 1 and 3. In the preferred embodiment, lower inner wall plate section 18 and lower outer wall plate section 20 would extend generally perpendicular to one another, and the entire top wall plate 14 is specifically designed to closely approximate the general shape of the drywall corner bead 80 which is to be fit within the retaining body 12 as shown best in FIGS. 1 and 3a. Of course, it should be noted that the curvature of top section 16 and relative lengths of lower inner wall plate section 18 and lower outer wall plate section 20 to top section 16 may be modified or changed depending upon the specific type of drywall corner bead 80 which is intended to be cut by the drywall corner bead cutting device 10 of the present invention, and such modifications would be understood by one skilled in the art of metal object fabrication. It should also be noted that an exact duplication of the curvature and/or shape of drywall corner bead 80 is not strictly necessary to permit the present invention to function correctly, although it is preferred that a reasonable approximation of the shape of drywall corner bead 80 be incorporated into the cross-sectional shape of top wall plate 14 as has been described above.

Mounted on, extending between and connecting the lower edges of lower inner wall plate section 18 and lower outer wall plate section 20 of top wall plate 14 are a pair of base plates 22a and 22b which, in the preferred embodiment, would be positioned adjacent opposite ends of the top wall plate 14 and extend approximately one fifth to one third of the length of top wall plate 14 thus leaving a central opening 24 between the base plates 22a and 22b. For structural strength purposes, it is preferred that the retaining body 12 be constructed as including these base plates 22a and 22b, however, it should be noted that the use of any appropriate inner and outer base wall retention devices such as generally horizontal projecting metal strips mounted on each of the lower ends of lower inner wall plate section 18 and lower outer wall plate section 20 may be substituted for the base plates 22a and 22b as described above so long as the intended purpose and functionality of retaining the drywall corner bead 80 within the retaining body 12 is maintained. Such substitution of equivalent drywall corner bead retaining elements should be understood to be within the scope of this description. Also, it should be noted that the center opening 24, while preferred to be part of the present invention, is not critical to the functionality of the present invention as it is merely designed to permit the cut off section of the drywall corner bead 80 to fall downwards out of the retaining body 12 to facilitate use of the drywall corner bead cutting device 10 of the present invention.

Finally, mounted on and extending forwards from the retaining body 12 is a pivot mount support plate 26 which provides a support structure for the pivot mounts for the cutting blade assemblies 40a and 40b. Also, mounted on and extending outwards from the retaining body 12 is a handle 28 which is designed to provide an easy-to-grasp location for supporting the retaining body 12 of the drywall corner bead cutting device 10 of the present invention. Of course, the positioning, size and shape of the handle 28 may be modified or changed as necessary to facilitate use of the drywall corner bead cutting device 10 of the present invention, and it may be expedient to position the handle 28 in such a manner that use of the cutting blade assemblies 40a and 40b is facilitated to render the cutting of the drywall corner bead 80 even easier by use of the present invention.

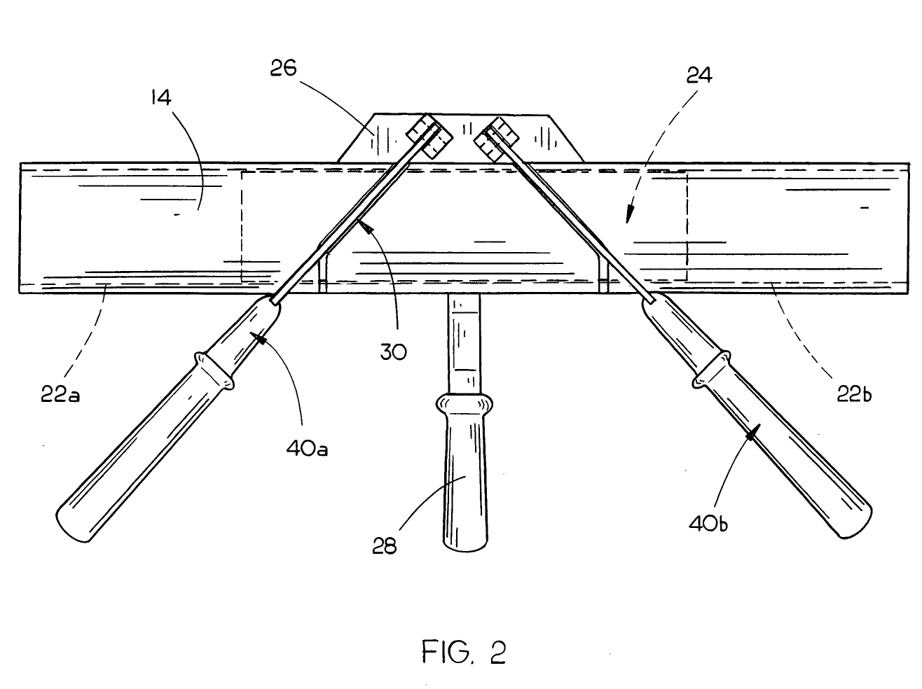

The cutting blade assemblies 40a and 40b are each pivotally mounted on the pivot mount support plate 26 of retaining body 12 as shown best in FIGS. 1 and 2. As each of the cutting blade assemblies 40a and 40b are generally identical to one another, except in terms of the curvature of the cutting blade which is reversed in each opposite cutting blade assembly 40a and 40b, the following description of cutting blade assembly 40a should be understood to apply equally to cutting blade assembly 40b. Cutting blade assembly 40a preferably includes a handle 42 which is pivotally mounted on pivot mount support plate 26 by a pivot block 44 having a pin extending there through which retains the mounted end of handle 42 there between to allow the handle 42 to pivot up and down relative to the pivot block 44. The handle 42 preferably further includes an outer gripping section 46 and an inner blade mounting section 48 on which the cutting blade 50 is mounted. In the preferred embodiment, cutting blade 50 is positioned such that it is generally aligned with a generally diagonal cutting slot 30 formed in top wall plate 14 of retaining body 12 as shown best in FIG. 2. This permits the cutting blade 50 to extend into the interior of retaining body 12 as shown best in FIGS. 3a and 3b, thus permitting the cutting blade 50 to engage the drywall corner bead 80 housed within the retaining body 12 for cutting thereof. In the preferred embodiment, the cutting blade 50 would be pivotable away from the retaining body 12 as shown in FIG. 3a and towards and into the retaining body 12 as shown in FIG. 3b via movement of handle 42. As can best be seen in FIG. 3b, when the handle 42 is pivoted downwards, the cutting blade 50 extends into the interior volume of the retaining body 12 thus cutting drywall corner bead 80 in a precise and efficient manner each and every time the drywall corner bead cutting device 10 is used.

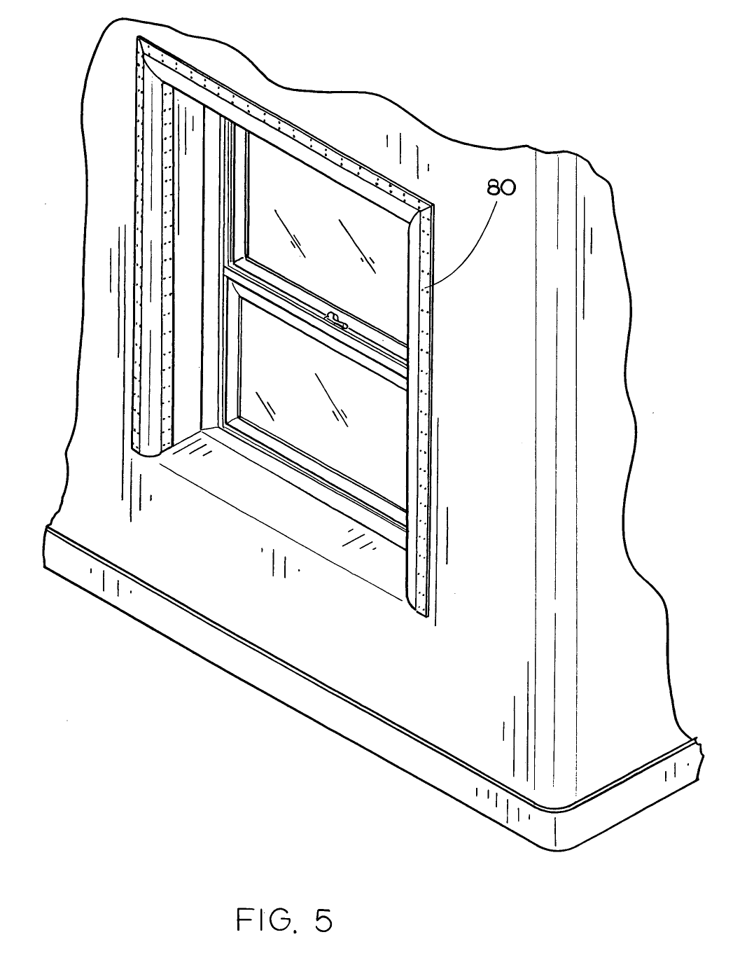

An important feature of the cutting blade 50 of the present invention is shown best in FIG. 2 in that the forward part 52 of cutting blade 50 extends generally parallel with handle 42 at approximately a 45.degree. angle to the longitudinal axis of the retaining body 12. However, the outer portion 54 of cutting blade 50 extends generally perpendicular to the longitudinal axis of retaining body 12 in order to cut the outer straight portion of drywall corner bead 80 in a straight, generally perpendicular cut. As shown best in FIG. 5, this cut shape is necessary to provide a correct fit for two sections of drywall corner bead 80 which abut one another at the ends thereof, as the curved top portion of drywall corner bead 80 includes a diagonal cut whereas the side faces of the drywall corner bead 80 connect in a perpendicular arrangement. Of course, it is not strictly necessary that cutting blade 50 be formed in this manner, but it is important to the correct functioning of the present invention that corner bead 80 be cut in as precise a manner as possible to permit adjacent sections of drywall corner bead 80 to abut one another with very little gap there between.

An additional feature of the cutting blade assembly 40a of the present invention is that the cutting blade 50 may be constructed to be removable and replaceable from handle 42, and specifically blade mounting section 48 of handle 42, such that when a cutting blade 50 becomes dull or is damaged, it may be quickly and easily replaced to permit the drywall corner bead cutting device 10 of the present invention to continue to function correctly. Also, the cutting blade 50 may be constructed of any appropriate cutting materials, although it is preferred that a razor blade-like cutting blade be used with the present invention in order to provide consistently accurate and repeatable cutting results.

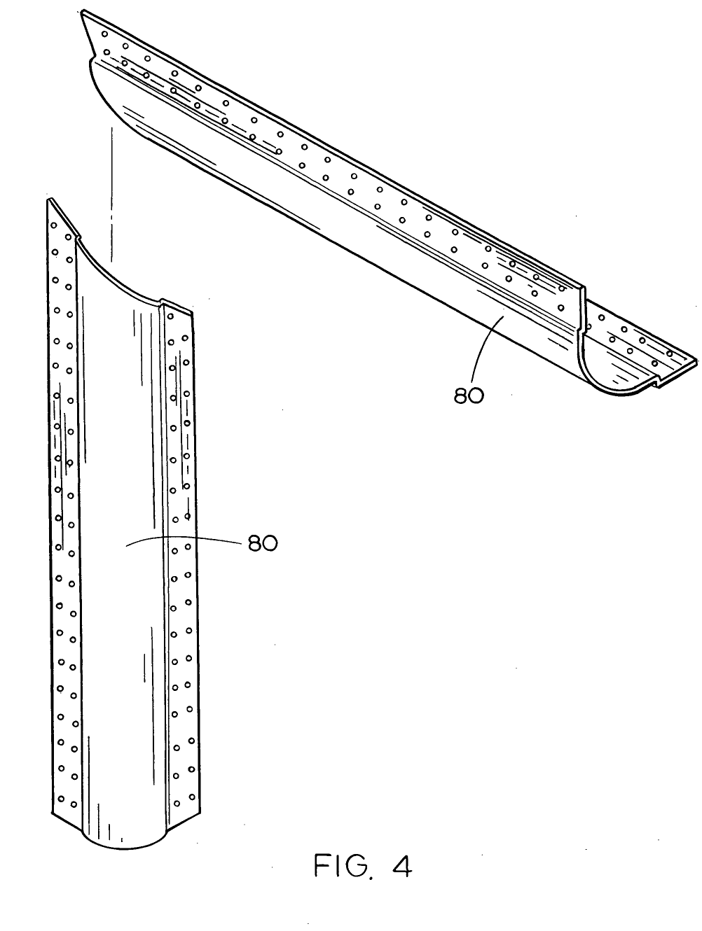

The present invention would be used in the following manner. Once the measurements are taken by the drywaller as to the proper lengths of the sections of drywall corner bead 80, the drywall corner bead 80 is cut to the approximate length of the section and the end of the rough cut drywall corner bead 80 is inserted into the retaining body 12 of the drywall corner bead cutting device 10 of the present invention until the rough cut drywall corner bead 80 is positioned where the cut should take place. The handle 42 of the cutting blade assembly 40 is then lowered to force the cutting blade 50 into contact with the rough cut drywall corner bead 80 through the generally diagonal cutting blade slot 30. By forcing the handle 42 downwards, the cutting blade 50 is driven down and through the rough cut drywall corner bead 80 thus cutting the rough cut drywall corner bead 80 in the desired location and producing an accurate and dependable cut in the rough cut drywall corner bead 80 which will permit the drywall corner bead 80 to be positioned and abut the adjacent section of drywall corner bead 80 surrounding the window, as shown in FIGS. 4 and 5. The handle 42 is then moved upwards removing the cutting blade 50 from contact with the drywall corner bead 80, the end portion of the drywall corner bead 80 falls downwards through central opening 24 for discarding thereof, and the cut drywall corner bead 80 is then removed from the retaining body 12. It should be noted that due to the cross-sectional shape of the retaining body 12 being generally similar to the cross-sectional shape of the drywall corner bead 80, lateral movement of the drywall corner bead 80 is restricted which ensures an accurate and clean cut of the drywall corner bead 80 by the cutting blade 50 each time the present invention is used. The drywall corner bead cutting device 10 is then ready for the next section of drywall corner bead 80 to be inserted for sectioning. The speed and relative ease of use of the present invention is thus clearly shown.

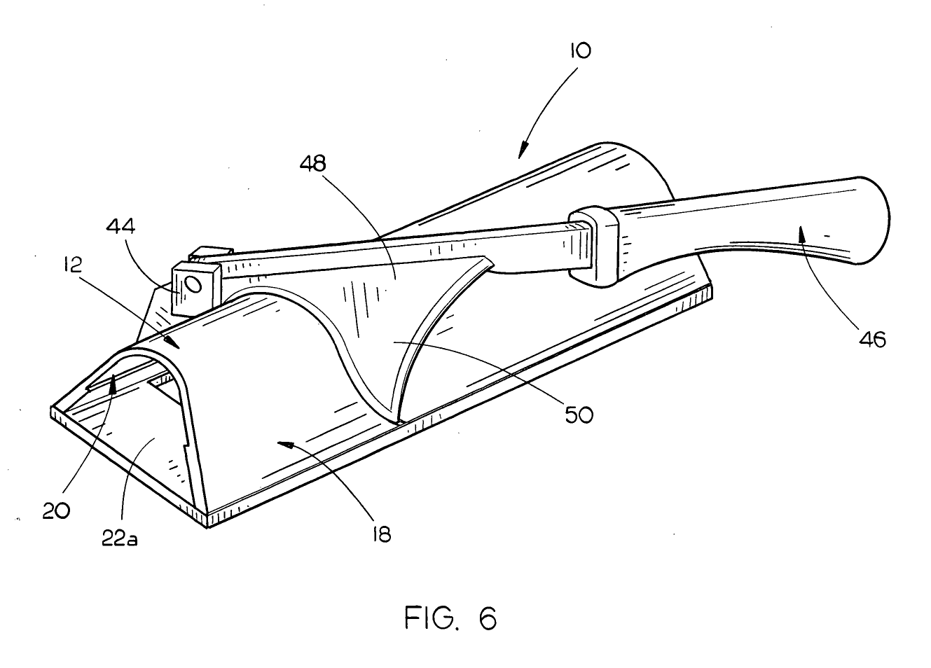

Finally, FIG. 6 discloses an alternative embodiment of the present invention which includes only a single cutting blade 50 for making either left or right-hand cuts to the drywall corner bead 80. The embodiment of FIG. 6 would be used in the manner described above, but it has been found that the use of such a simplified version of the present invention may be beneficial in that the simplified version is easier to carry and is smaller than the embodiment of FIG. 1. The only disadvantage is that the simplified version would require the user to have two separate units for performing cuts on the drywall corner bead 80, one for left-hand cuts and one for right-hand cuts, but depending on the user, such a requirement may be offset by the increased ease of use and improved transport capabilities of the simplified version of FIG. 6.

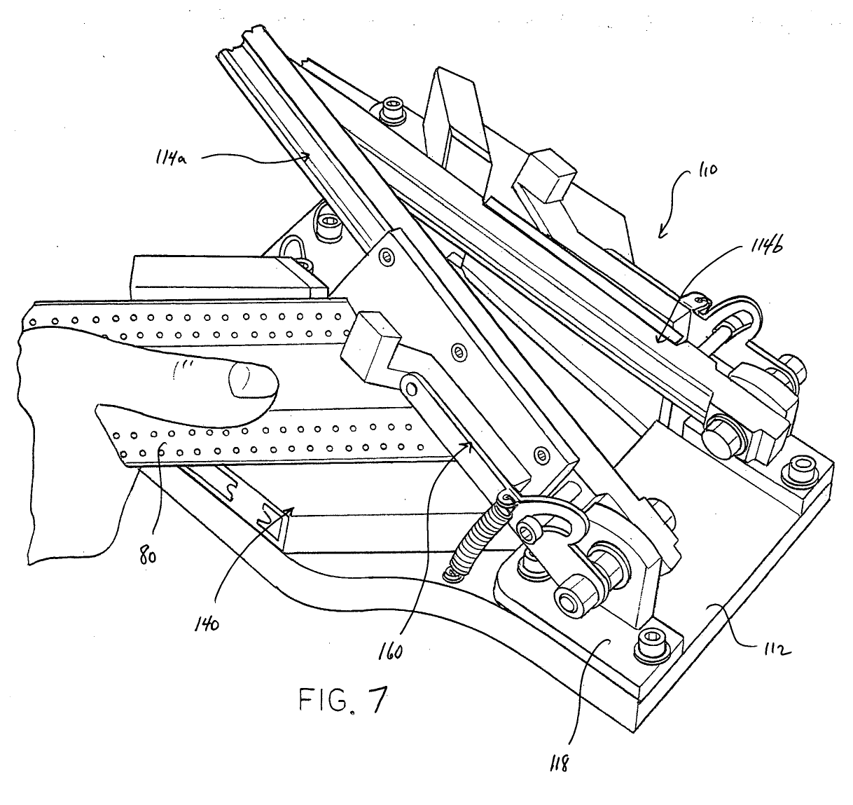

A preferred alternative embodiment of the drywall corner bead cutting device of the present invention is shown best in FIGS. 7-15 as including a significantly modified configuration of the cutting elements of the present invention. Specifically, the drywall corner bead cutting device 110 is shown as including a cutting device base 112 which preferably constructed of a sturdy metal material, and on top of which are mounted left and right cutting blade assemblies 114a and 114b which, in the preferred embodiment, are generally identical to one another, therefore, the following description of cutting blade assembly 114a should be understood to apply equally to cutting blade assembly 114b.

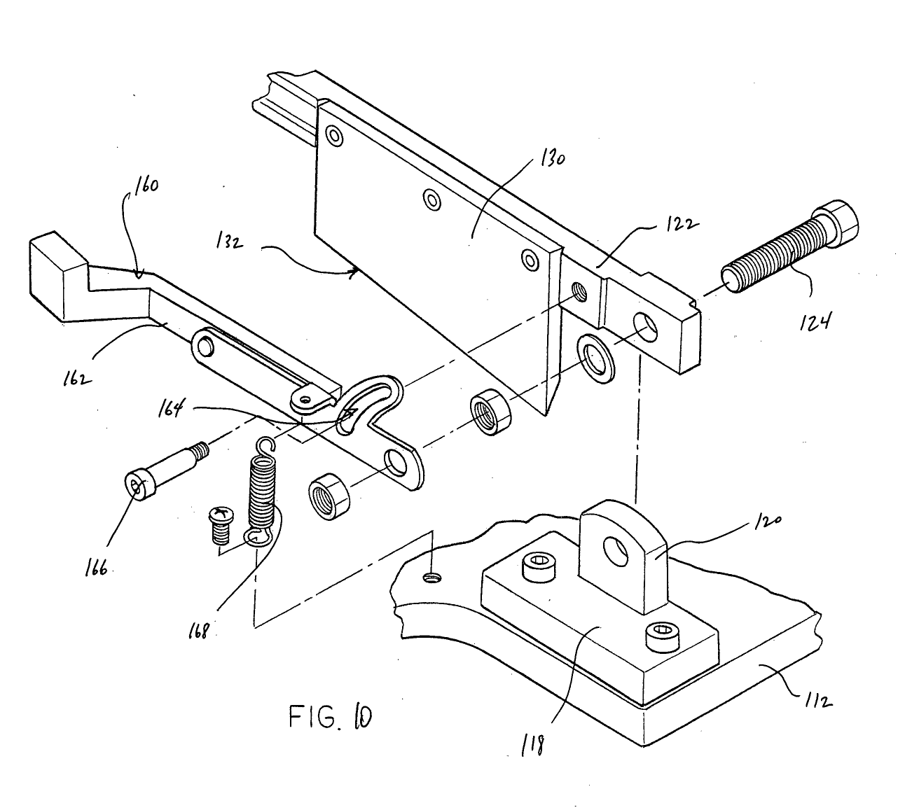

Cutting blade assembly 114a is shown best in FIGS. 7-11 as including two main sections, the cutting arm section 116 and the drywall corner bead support section 140 on which the drywall corner bead 80 to be cut is supported. The cutting arm section 116 preferably includes a cutting arm pivot mount 118 which is mounted on the upper surface of cutting device base 112, and which includes an upward extending arm support member 120. As shown best in FIG. 10, the cutting arm 122 is pivotably mounted on the arm support member 120 of cutting arm pivot mount 118 by the bolt 124 which extends through the cutting arm 122 and arm support member 120. In this manner, the cutting arm 122 may be pivoted about the bolt 124 for cutting of drywall corner bead 80 by the drywall corner bead cutting device 110 of the present invention.

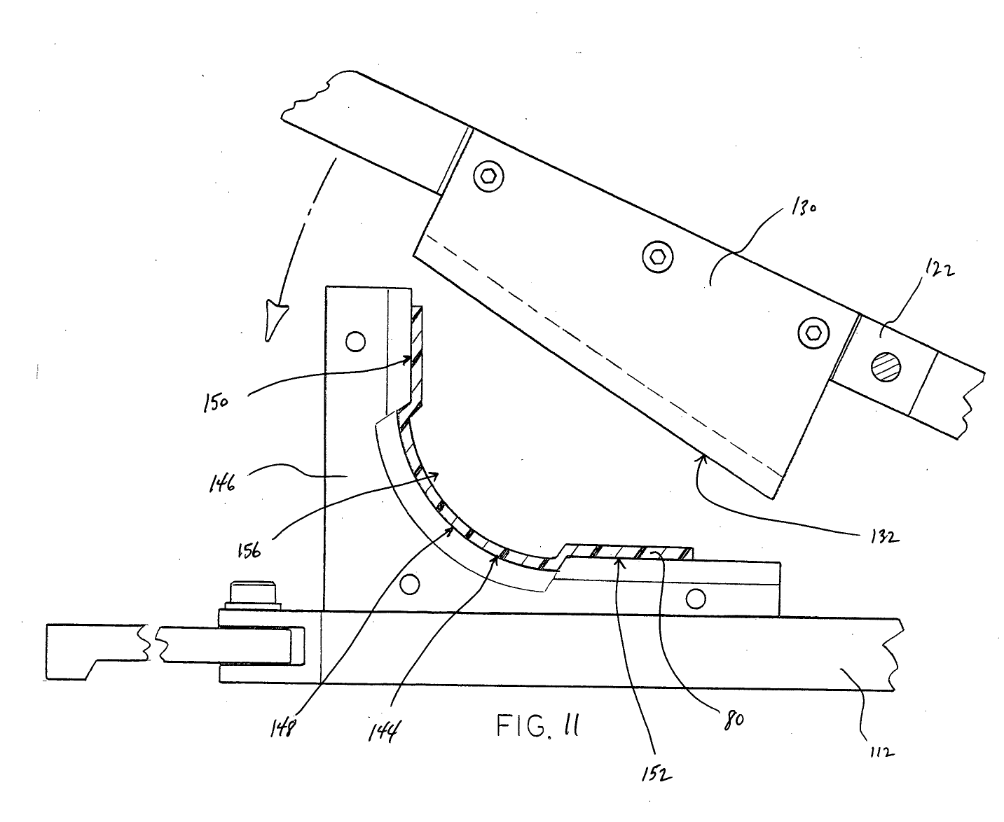

In the preferred embodiment, the cutting arm 122 would have a length of approximately 8 to 12 inches and would be constructed of a sturdy metal material with a plastic or rubber handle grip 126 affixed to the outer end 128 of the cutting arm 122. Mounted on the cutting arm 122 intermediate the bolt 124 and outer end 128 is cutting blade 130 which, in the preferred embodiment, would consist of a generally rectangular metal plate which extends downwards from the cutting arm 122 and is bolted thereto to securely mount the cutting blade 130 on the cutting arm 122. The cutting edge 132 of cutting blade 130 would be positioned at the base of cutting blade 130 and would preferably be angled downwards from outer end to inner end, as shown best in FIGS. 10 and 11, with the cutting edge 132 being positioned adjacent the drywall corner bead support section 140 as will be described later in this disclosure. In the preferred embodiment, the cutting blade 130 would preferably be constructed of a high-strength carbon steel metal material or the like which will generally insure a long usable life span for the cutting blade 130 in addition to generally promoting a sharp cutting edge 132 to facilitate sectioning of the drywall corner bead 80. Of course, as with each of the elements described herein, various other types of construction materials may be used with the present invention, and substitution of construction materials which do not significantly degrade the functionality of the present invention should be understood to be part of this disclosure. It should also be noted that the configuration of cutting blade 130, particularly cutting edge 132 may be modified or changed depending on the type of drywall corner bead 80 being cut by the present invention, and such modifications will likely be determined through field use of the device.

The drywall corner bead support section 140 is shown best in FIGS. 7-9 and 11 as including a bead support structure 142 which is generally L-shaped in cross-sectional shape and which includes a base wall 144 which is mounted on the cutting device base 112, a corner bead support wall 146 which is spaced from the base wall 144 and which has a cross sectional shape generally identical to the cross-sectional shape of the drywall corner bead 80 with which it is to be used for cutting thereof and a bead support section cutting blade 146 which is positioned on the inner edge of the bead support structure 142 generally adjacent the position of cutting blade 130 such that the cutting blade 130 on cutting arm 122 and bead support section cutting blade 146 cooperate to section the drywall corner bead 80 at the cutting area where the cutting blade 130 on cutting arm 122 and bead support section cutting blade 146 interact.

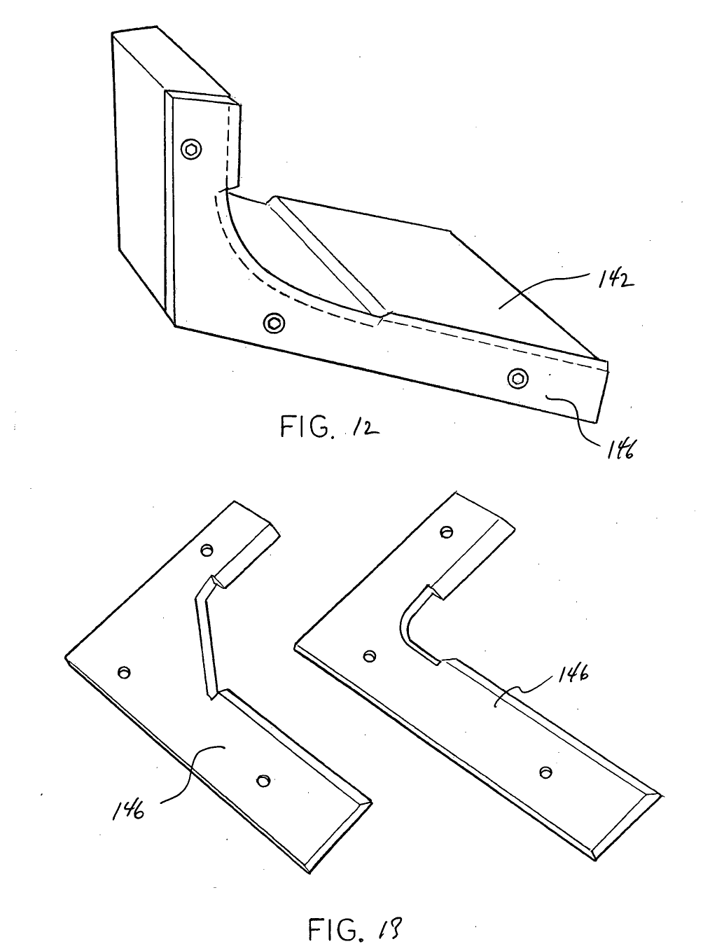

As shown in best in FIGS. 7, 8 and 11, the bead support structure 142, particularly corner bead support wall 144, includes a bullnose support section 148 and wing support sections 150 and 152 which generally conform to the cross-sectional shape of the drywall corner bead 80 when it is placed on the corner bead support wall 144. Of course, the exact size, shape and dimensions of the corner bead support wall 144 may be modified or changed, and, in fact, it is expected that the present invention will be provided with several different sizes and shapes of bead support structures 142 including corner bead support walls 144 having variations on their configuration, such as that shown in FIG. 12, and the inclusion of such alternate shapes should be understood to be part of this invention. Also, it should be noted that the bead support section cutting blade 146 would be generally L-shaped and bolt to the inner end of the bead support structure 142 as shown in FIGS. 11, 12 and 13, such that the bead support section cutting blade 146 engages substantially all of the outer wall surface of the drywall corner bead 80 at the point of the cut being made when the drywall corner bead 80 is placed on the bead support structure 142. To this end, the bead support section cutting blade 146 will preferably include shapes generally identical to the cross-sectional shape of the bead support structure 142 and particularly the shape of corner bead support wall 144. As can be seen in FIG. 13, due to the several different common shapes of drywall corner bead 80 which are presently used in the drywall industry, it is preferred that the present invention include both bead support structures 142 and bead support section cutting blades 146 which conform to the various cross-sectional shapes of the different configurations of drywall corner bead 80.

An additional important element of the drywall corner bead cutting device 110 of the present invention is shown best in FIGS. 7, 8 and 10, and that is the safety device 160 which is intended to prevent accidental insertion of a user's extremities into the cutting area 156 between the cutting blade 130 and bead support section cutting blade 146 during use thereof. The relatively simple mechanical design of the safety device 160 acts to insure that accidental dismemberment should not occur, and the safety device 160 preferably includes the following elements. The safety bar 162 extends forward from and is pivotably connected to the bolt 124 which pivotably supports the cutting arm 122 on arm support member 120 of cutting arm pivot mount 118. The safety bar 162 would extend forward to a position generally adjacent the upper wing support section 150 of corner bead support 144 to generally restrict access to the ctting area 156 defined by the cutting blade 130 and bead support section cutting blade 146 when the safety bar 162 is in its access prevention position.

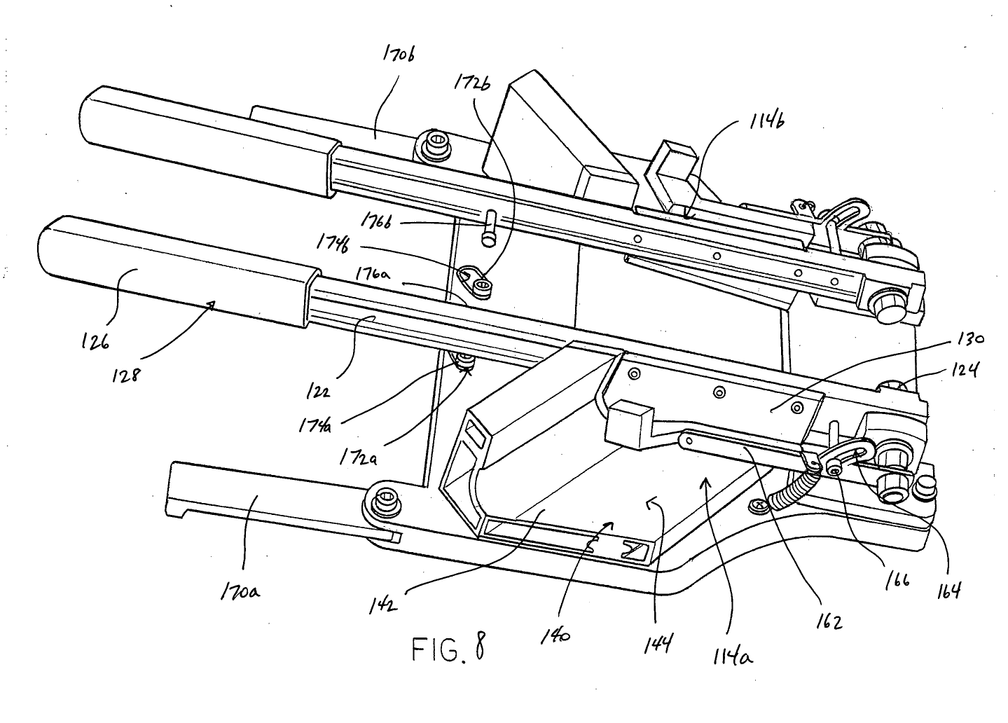

Mounted on the safety bar 162 is a curved slot 164 through which extends a pin 166 which extends into and is secured on the cutting arm 122, as shown best in FIGS. 8 and 10. The pin 166 and curved slot 164 cooperate such that when the cutting arm 122 is in its lowered position as shown in FIG. 8, the safety bar 162 is positioned in its access prevention position. As the cutting arm 122 is lifted, however, the pin 166 slides upwards within curved slot 164 until is contacts the topmost portion of curved slot 164. This means that as the cutting arm 122 is lifted, the safety bar 162 remains in its access prevention position until the cutting arm 122 is pivoted beyond a certain position as determined by the length of curved slot 164. This prevents unintentional extension of extremities into the cutting area 156 of the cutting blade assembly 114a, as might occur if the cutting arm 122 were not being fully opened prior to insertion of the drywall corner bead 80 to be cut. The safety bar 162 is then lifted upwards with continued rotation of cutting arm 122, thus lifting the safety bar 162 into its open position, thus permitting drywall corner bead 80 to be inserted into the cutting blade assembly 114a. As the cutting arm 122 is brought downwards, biasing spring 168 pulls the safety bar 162 downwards into contact with the drywall corner bead 80 thus returning the safety bar 162 to its access prevention position and preferably and hopefully preventing insertion of extremities into the cutting area 156 of the cutting blade assembly 114a. The safety device 160 thus helps to prevent unintentional injury resulting from improper use of the drywall corner bead cutting device 110 of the present invention. Of course, various other types of safety devices may be used with the present invention, but it has been found that the elegant simplicity of the safety device 160 as described herein fulfills its intended function very well.

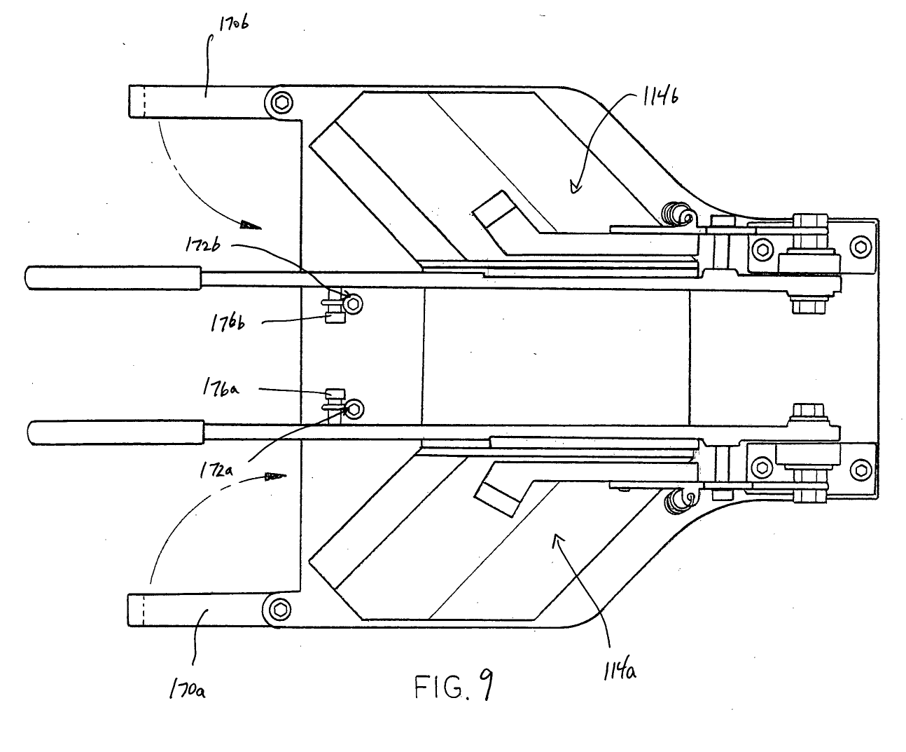

Two further features of the present invention are shown best in FIGS. 8 and 9, specifically referring to the stabilizing arms 170a and 170b pivotably mounted on and positioned on the forward section of cutting device base 112 for providing additional stability to the drywall corner bead cutting device 110 when it is being used, and cutting arm locking devices 172a and 172b which lock the cutting arms 122 in their closed position when the device is not in use. In the preferred embodiment, the cutting arm locking devices 172a and 172b would include securement bands 174a and 174b which connect to pins 176a and 176b positioned on the cutting arms 122, although the precise type of cutting arm locking devices 172a and 172b used with present invention are not particularly critical to the functionality of the invention, so long as the intended function of retaining the cutting arms 122 in closed position is enabled.

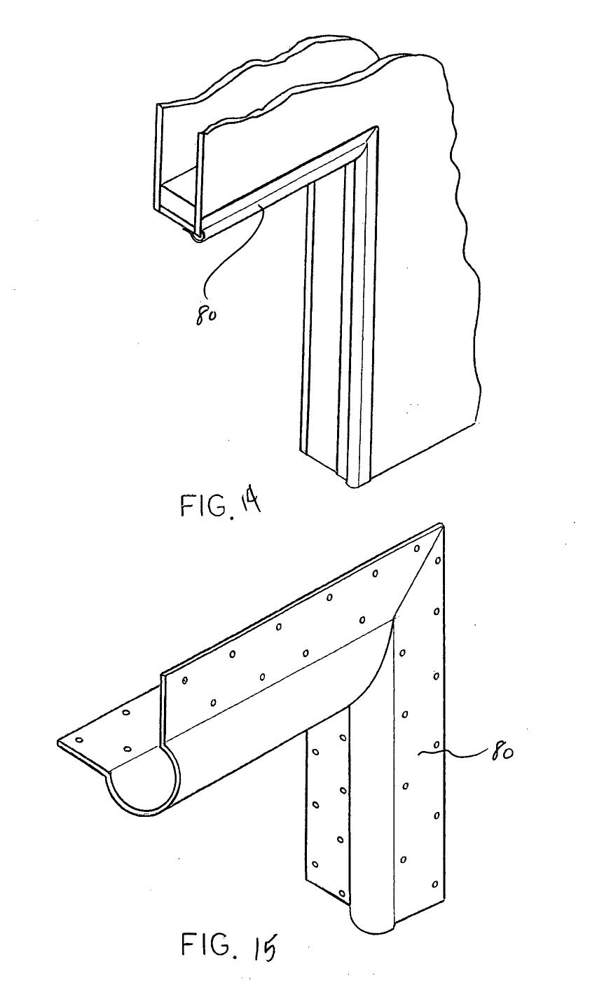

Use of the dry wall corner bead cutting device 110 is quite simple yet still provides an extremely accurate and precise 45 degree angle cut to the section of drywall corner bead 80 being cut. The user would simply place the drywall corner bead 80 in the bead support structure 142 against corner bead support wall 144 (as shown in FIGS. 7 and 11), then raise the cutting arm 122 upwards until the safety device 160, particularly safety bar 162, is moved upwards to permit the drywall corner bead 80 to be slid underneath. Once the drywall corner bead 80 is positioned in its preferred position, the cutting arm 122 is lowered by grasping the handle grip 126 thereon to bring the cutting edge 132 of cutting blade 130 into contact with the drywall corner bead 80. The interaction between the cutting blade 130 and bead support section cutting blade 146 quickly and accurately sections the drywall corner bead 80 along the plane defined by the cutting blade 130 and bead support section cutting blade 146 within the cutting area 156, thus resulting in a 45 degree angle cut in the drywall corner bead 80. Likewise, cutting blade assembly 114b would be used to make a 45 degree angle cut having the opposite orientation, thus permitting two sections of drywall corner bead 80 to be abutted to one another as shown in FIGS. 14 and 15 to form a generally perfect 90 degree angle corner. It is thus seen that the alternative embodiment of the drywall corner cutting bead device 110 as thus described provides a simple and quick yet accurate and efficient device for creating precisely angled cuts of drywall corner bead 80.

It is to be understood that numerous additions, modifications and substitutions may be made to the drywall corner bead cutting device 10 of the present invention which fall within the intended broad scope of the appended claims. For example, the precise angle at which cutting blade assemblies 40a and 40b are mounted may be modified or changed depending upon the angle of cut desired, and accordingly the shape of cutting blade 50 would be likewise modified to accommodate a different angle of cut. Such modifications would be necessary if one were to use the present invention to make cuts intended for 30 degree, 45 degree or even 60 degree angles surrounding windows, the occurrence and use of which is becoming more and more popular. Also, the specific size, shape and construction materials used in connection with the present invention may be modified or changed depending upon the needs of the user and/or manufacturer of the present invention and so long as such modifications do not significantly degrade or destroy the functional features of the present invention, they should be understood to be part of the present specification. Finally, it should be noted that the specific design features of the drywall corner bead cutting device 10 of the present invention may be modified or changed to accommodate various sizes and shapes of drywall corner beads as are commonly found in the industry, and such modifications would be understood by one skilled in the art of metal fabrication.

There has therefore been shown and described a drywall corner bead cutting device 10 which accomplishes at least all of its intended objectives.

What is claimed and desired to be secured by Letters Patent is as follows:

1. An improved drywall corner bead cutting device comprising:
a cutting device base;
at least one cutting blade assembly mounted on said cutting device base including;
a corner bead support section including a corner bead support structure mounted on said cutting device base and having a corner bead support wall operative to engage the upper wall of a drywall corner bead having a nose and wing sections, said corner bead support wall including a nose support section and opposite wing support sections for engaging and supporting the upper wall of a drywall corner bead having a longitudinal axis;
a corner bead support structure cutting blade mounted on said corner bead support structure, said corner bead support structure cutting blade generally diagonally aligned relative to said corner bead support wall such that said corner bead cutting structure cutting blade engages a drywall corner bead supported thereon to cut the drywall corner bead at an angle not perpendicular to the longitudinal axis of the drywall corner bead;
a cutting arm section including a pivotably mounted cutting arm, handle means and a cutting blade mounted on said cutting arm, said cutting blade positioned adjacent to and parallel with said corner bead support structure cutting blade; and
said cutting blade and said corner bead support structure cutting blade cooperatively operative to cut drywall corner bead supported on said corner bead support wall and extending beyond said corner bead support structure cutting blade into a cutting area defined by interaction of said cutting blade and said corner bead support structure cutting blade via pivoting movement of said cutting arm to drive said cutting blade and said corner bead support structure cutting blade into and through a drywall corner bead thereby dividing the drywall corner bead along a diagonal cut.

2. The improved drywall corner bead cutting device of claim 1 further comprising a safety bar operative to pivot in conjunction with pivoting of said cutting arm between an open position where said safety bar generally does not restrict access to said cutting area upon said cutting arm being pivoted away from said corner bead support wall and an access prevention position at least partially restricting access to said cutting area upon said cutting arm being pivoted to move said cutting blade into the proximity of and then engage said corner bead support structure cutting blade.

3. The improved drywall corner bead cutting device of claim 1 wherein said cutting blade is generally vertically aligned.

4. The improved drywall corner bead cutting device of claim 1 further comprising two cutting blade assemblies each mounted on said cutting device base and including two cutting arms mounted extending generally parallel with one another and two corner bead support structures each operatively associated with one of said two cutting blade assemblies, said two corner bead support structures extending generally perpendicular to one another and each positioned externally adjacent said operatively associated one of said two cutting arms such that opposite orientations of cuts are made by said two cutting blade assemblies.

5. An improved drywall corner bead cutting device comprising:
a cutting device base;
at least one cutting blade assembly mounted on said cutting device base including;
a corner bead support section including a corner bead support structure mounted on said cutting device base and having a corner bead support wall operative to engage the upper wall of a drywall corner bead having a nose and wing sections, said corner bead support wall including a nose support section and opposite wing support sections for engaging and supporting the upper wall of a drywall corner bead having a longitudinal axis;
a corner bead support structure cutting blade mounted on said corner bead support structure, said corner bead support structure cutting blade generally diagonally aligned relative to said corner bead support wall such that said corner bead cutting structure cutting blade engages a drywall corner bead supported thereon to cut the drywall corner bead at an angle not perpendicular to the longitudinal axis of the drywall corner bead;
a cutting arm section including a pivotably mounted cutting arm, handle means and a cutting blade mounted on said cutting arm, said cutting blade positioned adjacent to and parallel with said corner bead support structure cutting blade;
said cutting blade and said corner bead support structure cutting blade cooperatively operative to cut drywall corner bead supported on said corner bead support wall and extending beyond said corner bead support structure cutting blade into a cutting area defined by interaction of said cutting blade and said corner bead support structure cutting blade via pivoting movement of said cutting arm to drive said cutting blade and said corner bead support structure cutting blade into and through a drywall corner bead thereby dividing the drywall corner bead along a diagonal cut; and
a safety device operative to move in conjunction with pivoting of said cutting arm between an open position where said safety device generally does not restrict access to said cutting area upon said cutting arm being pivoted away from said corner bead support wall and an access prevention position at least partially restricting access to said cutting area upon said cutting arm being pivoted to move said cutting blade into the proximity of and then engage said corner bead support structure cutting blade.

6. An improved drywall corner bead cutting device comprising:
a cutting device base;
two cutting blade assembly mounted on said cutting device base, each of said two cutting blade assemblies including;
a corner bead support section including a corner bead support structure mounted on said cutting device base and having a corner bead support wall operative to engage the upper wall of a drywall corner bead having a nose and wing sections, said corner bead support wall including a nose support section and opposite wing support sections for engaging and supporting the upper wall of a drywall corner bead having a longitudinal axis;
a corner bead support structure cutting blade mounted on said corner bead support structure, said corner bead support structure cutting blade generally diagonally aligned relative to said corner bead support wall such that said corner bead cutting structure cutting blade engages a drywall corner bead supported thereon to cut the drywall corner bead at an angle not perpendicular to the longitudinal axis of the drywall corner bead;
a cutting arm section including a pivotably mounted cutting arm, handle means and a cutting blade mounted on said cutting arm, said cutting blade positioned adjacent to and parallel with said corner bead support structure cutting blade;
said cutting blade and said corner bead support structure cutting blade cooperatively operative to cut drywall corner bead supported on said corner bead support wall and extending beyond said corner bead support structure cutting blade into a cutting area defined by interaction of said cutting blade and said corner bead support structure cutting blade via pivoting movement of said cutting arm to drive said cutting blade and said corner bead support structure cutting blade into and through a drywall corner bead thereby dividing the drywall corner bead along a diagonal cut; and
the two corner bead support structures extending generally perpendicular to one another and each positioned externally adjacent said operatively associated one of the two cutting arms such that opposite orientations of cuts are made by said two cutting blade assemblies.
